(19) United States
(12) Patent Application Publication
(10) Pub. No.: US 2026/0186845 A1
(43) Pub. Date: Jul. 2, 2026

(54) RESOURCE ALLOCATION METHOD AND ELECTRONIC DEVICE

(71) Applicant: Lenovo (Beijing) Limited, Beijing (CN)

(72) Inventors: Zheyi ZHU, Beijing (CN); Ming LU, Beijing (CN); Wang SHI, Beijing (CN)

(21) Appl. No.: 19/429,117

(22) Filed: Dec. 22, 2025

(30) Foreign Application Priority Data
Dec. 31, 2024 (CN) 202411996853.5

(51) Int. Cl. G06F 9/50

(52) U.S. Cl. CPC G06F 9/5038

(57) ABSTRACT

A resource allocation method includes determining target resources needed by each of a plurality of large models for task processing. Different ones of the plurality of large models are used to process different types of tasks. The target resources include at least computing power resources. The method further includes predicting, based on historical records, a number of candidate tasks and types of the candidate tasks to be processed in a future time segment, determining, based on the number and the types, a resource allocation strategy for the future time segment according to the target resources needed by each of the plurality of large models for task processing, and allocating, based on the resource allocation strategy, initial target resources for each of the plurality of large models in the future time segment, and allocating reserved resources. The reserved resources are reserved from total target resources.

### CROSS-REFERENCE TO RELATED APPLICATION

This application claims priority to Chinese Patent Application No. 202411996853.5, filed on Dec. 31, 2024, the entire content of which is incorporated herein by reference.

### TECHNICAL FIELD

The present disclosure generally relates to the field of model processing technologies, and, more particularly, to a resource allocation method and an electronic device.

### BACKGROUND

With the rapid development of large models, deploying the large models on enterprise systems to solve business problems is becoming increasingly common.

Because of varying business scenarios, users may need to simultaneously utilize multiple large models to complete inference tasks for different business purposes. System resources are fixed, while the resource needs of inference operations of the large models are elastic. If fixed resources are allocated to each large model, as resource needs change, the resources allocated to one large model may be insufficient to complete its inference tasks, while the resources allocated to another large model may not be effectively utilized.

### SUMMARY

In accordance with the disclosure, there is provided a resource allocation method including determining target resources needed by each of a plurality of large models for task processing. Different ones of the plurality of large models are used to process different types of tasks. The target resources include at least computing power resources. The method further includes predicting, based on historical records, a number of candidate tasks and types of the candidate tasks to be processed in a future time segment, determining, based on the number and the types, a resource allocation strategy for the future time segment according to the target resources needed by each of the plurality of large models for task processing, and allocating, based on the resource allocation strategy, initial target resources for each of the plurality of large models in the future time segment, and allocating reserved resources. The reserved resources are reserved from total target resources.

Also in accordance with the disclosure, there is provided an electronic device including a processor and a memory storing instructions that, when executed by the processor, cause the electronic device to determine target resources needed by each of a plurality of large models for task processing. Different ones of the plurality of large models are used to process different types of tasks. The target resources include at least computing power resources. The instructions, when executed by the processor, further cause the electronic device to predict, based on historical records, a number of candidate tasks and types of the candidate tasks to be processed in a future time segment, determine, based on the number and the types, a resource allocation strategy for the future time segment according to the target resources needed by each of the plurality of large models for task processing, and allocate, based on the resource allocation strategy, initial target resources for each of the plurality of large models in the future time segment, and allocate reserved resources. The reserved resources are reserved from total target resources.

Also in accordance with the disclosure, there is provided a non-transitory computer-readable storage medium storing instructions that, when executed by a processor, cause an electronic device including the processor to determine target resources needed by each of a plurality of large models for task processing. Different ones of the plurality of large models are used to process different types of tasks. The target resources include at least computing power resources. The instructions, when executed by the processor, further cause the electronic device to predict, based on historical records, a number of candidate tasks and types of the candidate tasks to be processed in a future time segment, determine, based on the number and the types, a resource allocation strategy for the future time segment according to the target resources needed by each of the plurality of large models for task processing, and allocate, based on the resource allocation strategy, initial target resources for each of the plurality of large models in the future time segment, and allocate reserved resources. The reserved resources are reserved from total target resources.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those of ordinary skill in the art, other drawings can be obtained according to these drawings without any creative work. Throughout the drawings, the same or similar reference numerals represent the same or similar elements. It should be understood that the drawings are schematic and that the originals and elements are not necessarily drawn to scale.

FIG. 1 is a flow chart of a resource allocation method consistent with embodiments of the present disclosure.

FIG. 2 is a flow chart of another resource allocation method consistent with embodiments of the present disclosure.

FIG. 3 is a flow chart of another resource allocation method consistent with embodiments of the present disclosure.

FIG. 4 is a flow chart of another resource allocation method consistent with embodiments of the present disclosure.

FIG. 5 is a flow chart of another resource allocation method consistent with embodiments of the present disclosure.

FIG. 6 is a flow chart of another resource allocation method consistent with embodiments of the present disclosure.

FIG. 7 is a schematic diagram showing task volumes of Application A, Application B, and Application C in a recording period, consistent with embodiments of the present disclosure.

FIG. 8 is a schematic diagram showing an application scenario of a resource allocation method consistent with embodiments of the present disclosure.

FIG. 9 is a schematic structural diagram of an electronic device consistent with embodiments of the present disclosure.

### DETAILED DESCRIPTION OF THE EMBODIMENTS

Various schemes and features of the present disclosure are described herein with reference to the accompanying drawings. The terms used in the present disclosure are only used to explain the specific embodiments of the present disclosure and are not intended to limit the scope of the present disclosure. It is understandable to those skilled in the art that with the development of technology and the emergence of new scenarios, the technical solutions provided in the embodiments of the present disclosure are also applicable to similar technical problems.

The terms “first/second/third” involved in the present disclosure are only used to distinguish similar objects, and do not represent a specific order for the objects. It is understood that objects described by “first/second/third” can be interchanged with a specific order or sequence where permitted, such that the embodiments of the present disclosure described here can be implemented in an order other than that illustrated or described here. The terms “including,” “comprising,” or “having,” and any variations thereof, are intended to cover a non-exclusive inclusion, such that a process, method, system, product, or apparatus that comprises a list of elements is not necessarily limited to those elements but may include other elements not expressly listed or inherent to such process, method, product, or device. Unless otherwise defined, all technical and scientific terms used in the present disclosure have the same meaning as those generally understood by those skilled in the art. The terms used in the present disclosure are only for the purpose of description and are not intended to limit the scope of the present disclosure.

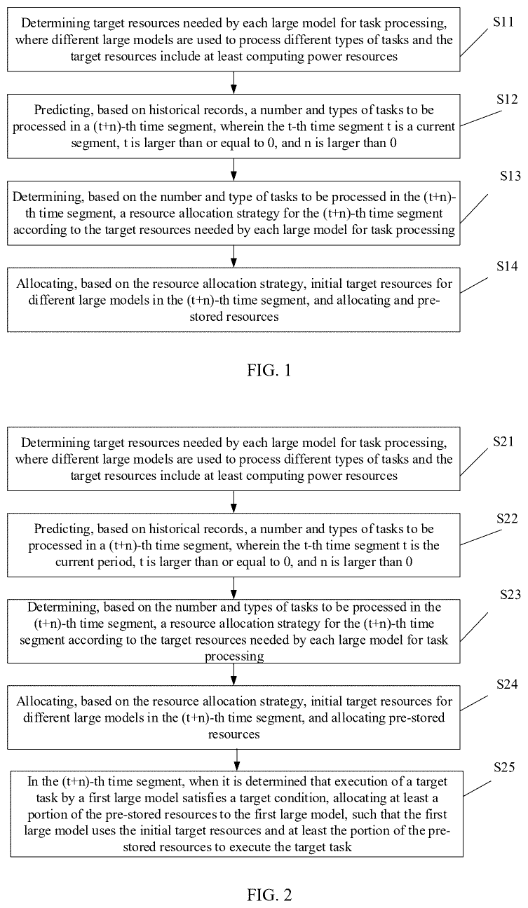

The present disclosure provides a resource allocation method. In one embodiment, as shown in FIG. 1, which is a flow chart of a resource allocation method consistent with the present disclosure, the method includes:
S11: determining target resources needed by each large model for task processing, where different large models are used to process different types of tasks, and the target resources of one large model at least include computing power resources;
S12: predicting the number and types of tasks to be processed (also referred to as “candidate tasks”) in a (t+n)-th time segment based on historical records, where a t-th time segment is a current time segment, t is larger than or equal to 0, and n is larger than 0, and the (t+n)-th time segment is also referred to as a “future time segment”;
S13: determining a resource allocation strategy for the (t+n)-th time segment based on the number and types of tasks to be processed in the (t+n)-th time segment and the target resources needed by each large model for task processing; and
S14: allocating initial target resources for different large models in the (t+n)-th time segment based on the resource allocation strategy, and allocating reserved resources, where the reserved resources are a portion of total target resources reserved to ensure the processing efficiency of the tasks processed in the (t+n)-th time segment.

With the rapid development of large models, deploying large models on enterprise systems to solve business problems is becoming increasingly common.

Because of varying business scenarios, users may need to simultaneously utilize multiple large models to complete inference tasks for different business purposes. System resources are fixed, while the resource needs of large model inference operations are flexible. If fixed resources are allocated to each large model, as the resource needs of the large models change, the resources allocated to one large model may be insufficient to support its inference tasks, while the resources allocated to another large model may not be effectively utilized.

In the present disclosure, the target resources needed by each large model for task processing may be determined, and the number and types of tasks to be processed in the (t+n)-th time segment may be predicted. Then, the resources may be allocated based on the predicted number and types of tasks to be processed in the (t+n)-th time segment and the target resources needed by each large model for task processing. This may ensure that each large model has the target resources it needs to process the corresponding task in the (t+n)-th time segment, to avoid wasting resources because of over-allocation or failing to complete tasks because of under-allocation. Furthermore, during resource allocation, the reserved resources may be allocated for different large models to ensure efficiency and accuracy of task inference, thereby ensuring system stability.

Multiple large models may be used to process different types of tasks, such as large language models for natural language text processing, large vision models for image analysis and processing, or large industry models for specific industries or fields.

Different large models may need different target resources to perform their corresponding tasks. Therefore, when multiple large models are deployed in a system, the target resources needed by each large model for task processing may be pre-determined.

The target resources may include at least computing power resources, which may be provided by devices such as a central processing unit (CPU), a graphics processing unit (GPU), a memory, or a storage. The target resources may also include video memory, etc.

The computing power resources needed by different large models may be related to a prompt word template and the number of input and output tokens of the task types. The complexity, structure, and length of the prompt word template may directly affect the number of tokens processed, and therefore the computational load. The number of input tokens may affect the computational effort needed for encoding and the amount of intermediate state storage needed. The number of output tokens may affect the decoding process, which is typically the most computationally intensive part.

For example, for a large model with a word length of lᵢₙ and a number of parameters of Nₚₐᵣₐₘₛ, the floating-point operations per second (FLOPs) needed by the encoding process may be calculated as FLOPs_{encode}. The FLOPs needed by the decoding process may be represented as FLOPs_{decode}, by predicting the output word length of lₒᵤₜ. The total number of FLOPs needed may be represented by FLOPsₜₒₜₐₗ, and may be calculated as:

$${FLOPs}_{e n c o d e} = O ( {N}_{p a r a m s} \times {l}_{i n} ) ;$$

$${FLOPs}_{d e c o d e} = O ( {N}_{p a r a m s} \times {l}_{out} \times {l}_{i n} ) ;$$

$${FLOPs}_{total} = {FLOPs}_{e n c o d e} + {FLOPs}_{d e c o d e} .$$

When calculating the memory resources needed for inference of a large model, the model structure, input data size, batch size, or data type may need to be considered. The memory needed for activation during forward and backward propagation may be proportional to the number of parameters and the layer size of the large model, and may be calculated as VRAM_{activation}. Each parameter in the large model may typically need float/8 bytes of storage space. For example, a float32 needs 4 bytes of storage space. The memory resources needed for the parameters can be determined as VRAMₚᵣₐₘₐₜₑᵣ. In addition, temporary variables, intermediate calculations, or buffer space during the computation may also need a certain amount of memory, which may be expressed as VRAM_{temporary}. The total needed video memory resources may be expressed as VRAMₜₒₜₐₗ, which may be calculated as:

$$V R A {M}_{activation} ( G B ) = O ( {N}_{p a r a m s} \times {l}_{i n} \times layersize ) ;$$

$$VRA {M}_{p arameter} ( G B ) = \frac{{N}_{p a r a m s} \times \frac{floa t}{8} bytes}{{1024}^{3}} ;$$

$$VRA {M}_{total} = V R A {M}_{activation} + V R A {M}_{p arameter} + V R A {M}_{temporay} .$$

When the system resources need to be allocated for the (t+n)-th time segment, the tasks that need to be processed in the system during the (t+n)-th time segment may be predicted. For example, the number of tasks that need to be processed during the (t+n)-th time segment and the type of each task may be predicted. Since different types of tasks need large models of different levels and sizes, when allocating the target resources of the system for a given t-th time segment to different large models, the type of each task to be processed may need to be determined. Based on the task type, the corresponding large model and the target resources allocated to it may be determined.

Where the t-th time segment is the current time segment, the (t+n)-th time segment may be a time segment after the current time segment, where t is a number larger than or equal to 0, and n is a number larger than 0.

The number and types of tasks to be processed during the (t+n)-th time segment may be predicted based on historical records. The number and types of tasks processed during the time segments in different periods of the historical records corresponding to the (t+n)-th time segment may be determined, and based on this, the number and types of tasks to be processed during the (t+n)-th time segment in the current period may be predicted.

For example, when the recording period is one day and the (t+n)-th time segment is between 1 PM and 2 PM on that day, the number and types of tasks processed during that time segment may be determined based on the historical records for the previous day or each of the previous five days. Based on this, the number and types of tasks to be processed during that time segment may then be predicted for that day. When the number of tasks processed during that time segment is m and the task type is the type 1, the number of tasks to be processed during that time segment may be predicted to be m, and the task type to be the type 1.

After determining the number and types of tasks to be processed in the (t+n)-th time segment, the resource allocation strategy for the (t+n)-th time segment, that is, the amount of the target resources to be allocated to each large model, may be determined, according to the target resources needed by each large model when performing task processing.

After determining the types of the tasks to be processed in the (t+n)-th time segment, the large models that will handle these task types may be determined based on the task type of each task. Further, based on the number of tasks corresponding to each task type and the target resources needed by the large model to handle tasks of that task type, the resources needed by the large model to handle tasks of that task type in the (t+n)-th time segment may be determined.

For example, it may be determined that the tasks to be processed in the (t+n)-th time segment include: tasks 1, tasks 2 and tasks 3, among which the number of the tasks 1 in the (t+n)-th time segment is m1, the number of the tasks 2 is m2, and the number of the tasks 3 is m3. The large model for processing tasks of the type of tasks 1 may be a large model 1, the large model for processing tasks of the type of tasks 2 may be a large model 2, and the large model for processing tasks of the type of tasks 3 may be a large model 3. The target resources needed by the large model 1 when processing tasks may be k1, the target resources needed by the large model 2 when processing tasks may be k2, and the target resources needed by the large model 3 when processing tasks may be k3. The number of tasks that large model 1 needs to perform in the (t+n)-th time segment may be predicted to be m1, and the resources needed for each task may be predicted to be k1. Therefore, the target resources needed for the large model 1 in the (t+n)-th time segment may be predicted to be k1×m1. The number of tasks that the large model 2 needs to perform in the (t+n)-th time segment may be predicted to be m2, and the resources needed for each task may be predicted to be k2. Therefore, the target resources needed by the large model 2 in the (t+n)-th time segment may be predicted to be k2×m2. The number of tasks that the large model 3 needs to perform in the (t+n)-th time segment may be predicted to be m3, and the resources needed for each task may be predicted to be k3. Therefore, the target resources needed for the large model 3 in the (t+n)-th time segment may be predicted to be k3×m3. The resource allocation strategy may be determined.

Afterwards, the target resources of the system in the (t+n)-th time segment may be allocated based on the resource allocation strategy. While allocating the corresponding initial target resources to each large model, the reserved resources must also be allocated. The reserved resources may be part of the resources reserved from the total target resources. During the resource allocation process, the reserved resources may not be allocated to any large model, but may be reserved to ensure the processing efficiency of the tasks processed in the (t+n)-th time segment. Therefore, when there is a sudden increase in tasks in the (t+n)-th time segment, or a sudden increase in the amount of data, the reserved resources may be used for execution, to avoid the inability to execute the corresponding tasks because of insufficient resources, thereby ensuring the smooth execution of each task in the (t+n)-th time segment.

In the resource allocation method disclosed in this embodiment, the target resources needed by each large model when performing task processing may be determined. Different large models may be used to process different types of tasks, and the target resources may include at least computing power resources. Based on the historical records, the number of tasks to be processed and the types of tasks may be predicted in the (t+n)-th time segment, where the t-th time segment may be the current moment segment with t larger than or equal to 0 and n larger than 0. Based on the number of tasks to be processed and the types of tasks in the (t+n)-th time segment, and according to the target resources needed by each large model when performing task processing, the resource allocation strategy for the (t+n)-th time segment may be determined. Based on the resource allocation strategy, the initial target resources of different large models in the (t+n)-th time segment may be allocated, and the reserved resources may be allocated. The reserved resources may be part of the resources reserved from the total target resources to ensure the processing efficiency of the tasks processed in the (t+n)-th time segment. The number and types of tasks to be processed in the (t+n)-th time segment may be determined, and then the resource allocation strategy may be determined based on the number and types of tasks to be processed in the (t+n)-th time segment and the target resources needed by each large model when processing the tasks. Based on this, the initial target resources of different large models in the (t+n)-th time segment and the allocated reserved resources may be allocated to ensure that each task to be processed in the (t+n)-th time segment is able to executed by the corresponding large model according to its needed target resources, ensuring that the large model has sufficient resources to execute the corresponding tasks and avoid resource waste and resource shortage.

Another embodiment of the present disclosure provides another resource allocation method, as shown in FIG. 2, including:
S21: determining target resources needed by each large model for task processing, where different large models may be used to process different types of tasks and the target resources may at least include computing power;
S22: predicting the number and types of tasks to be processed in the (t+n)-th time segment based on historical records, where the t-th time segment may be the current moment segment with t larger than or equal to 0 and n larger than 0;
S23: determining a resource allocation strategy for the (t+n)-th time segment based on the number and types of tasks to be processed in the (t+n)-th time segment and the target resources needed by each large model for task processing;
S24: allocating initial target resources to different large models in the (t+n)-th time segment based on the resource allocation strategy, and allocating reserved resources, where the reserved resources may be a portion of the total target resources reserved to ensure the processing efficiency of tasks to be processed in the (t+n)-th time segment; and
S25: in the (t+n)-th time segment, if it is determined that execution of a target task by a first large model meets a target condition, allocating at least a portion of the reserved resources to the first large model such that the first large model executes the target task using the initial target resources and at least the portion of the reserved resources, where the target condition may include the efficiency of the first large model executing the target task is lower than a first threshold and/or the number of tasks executed by the first large model is larger than a second threshold.

Based on the historical records, the number and types of tasks to be processed in the (t+n)-th time segment may be predicted. Based on the predicted number and types of tasks to be processed in the (t+n)-th time segment, the initial target resources and reserved resources may be allocated to the different large models in the (t+n)-th time segment according to the target resources needed by each large model for task processing. During the (t+n)-th time segment, each large model may use the initial target resources allocated to it to execute its corresponding tasks. For example, the large model 1 may execute the tasks 1 and 3 using its initial target resource k1, and the large model 2 may execute the tasks 2 using its initial target resource k2.

During the (t+n)-th time segment, if it is determined that the efficiency of the first large model in executing its corresponding target task is low, falling below a first threshold, for example, below 50%, the first large model may be considered to be resource-scarce. In this case, at least a portion of the reserved resources may be allocated to the first large model to increase its efficiency in executing the target task to the first threshold, thereby preventing the first large model from executing tasks with low efficiency.

Alternatively, during the (t+n)-th time segment, if it is determined that the number of tasks executed by the first large model is large, exceeding a second threshold, for example, larger than 150, the first large model may be considered to be executing a large number of tasks and may be resource-scarce. Therefore, at least a portion of the reserved resources may be allocated to the first large model to ensure the efficiency of the first large model in executing tasks and thereby prevent its low efficiency.

The reserved resources may be divided into several portions and allocated to different large models to compensate for resource shortages in the large models. Alternatively, the reserved resources may be allocated entirely to one large model, allowing it to utilize all the reserved resources to ensure efficient task execution.

Alternatively, the reserved resources may be allocated to one large model during a first time interval in the (t+n)-th time segment. After the first time interval ends, the large model may no longer need additional reserved resources. At this point, the reserved resources allocated to the large model may be reclaimed and may be allocated to other large models during other time intervals in the (t+n)-th time segment to facilitate task execution, thus preventing resource shortages in other large models.

For example, in the first time interval of the (t+n)-th time segment, the task execution efficiency of the first large model may be lower than the first threshold. At this time, the first portion of the reserved resources may be allocated to the first large model, and the first large model may use the initial target resources allocated to it and the first portion of the reserved resources to perform the corresponding tasks. After the first time interval ends, the task execution of the first large model may be completed, or the efficiency of the first large model in executing tasks may be larger than the first threshold. At this time, the reserved resources may recycle the first portion of the reserved resources allocated to the first large model, that is, the first large model may only use the initial target resources allocated to it to execute subsequent tasks and no longer use the first portion of the reserved resources to execute tasks. In the second time interval after the first time interval in the (t+n)-th time segment, when it is determined that the number of tasks executed by the second large model is larger than the second threshold, to avoid insufficient resources for the second large model, the second portion may be divided from the reserved resources and allocated to the second large model, such that the second large model may use the initial target resources allocated to it and the second portion of the reserved resources to execute tasks. The second portion of the reserved resources may be generated after the first portion is recycled into the reserved resources. Therefore, there may be no clear boundary between the first and second portions. That is, at least a portion of the first portion of the reserved resources allocated to the first large model in the first time interval may be allocated to the second large model as at least a portion of the second portion in the second time interval.

The resource allocation method disclosed in this embodiment may predict the number and types of tasks to be processed in the (t+n)-th time segment and allocate the corresponding initial target resources and reserved resources to different large models in the (t+n)-th time segment. This may allow, if the first large model performs the target tasks inefficiently or performs an excessive number of tasks in the (t+n)-th time segment, to allocate at least a portion of the reserved resources to the first large model, ensuring the first large model's efficiency in executing tasks and avoiding the inability to complete tasks promptly because of insufficient resources.

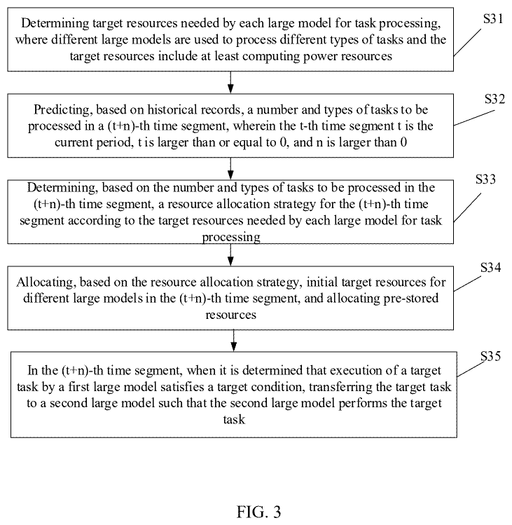

Another embodiment of the present disclosure provides another resource allocation method, as shown in FIG. 3, including:
S31: determining target resources needed by each large model for task processing, where different large models may be used to process different types of tasks and the target resources may at least include computing power;
S32: predicting the number and types of tasks to be processed in the (t+n)-th time segment based on historical records, where the t-th time segment may be the current moment segment with t larger than or equal to 0 and n larger than 0;
S33: determining a resource allocation strategy for the (t+n)-th time segment based on the number and types of tasks to be processed in the (t+n)-th time segment and the target resources needed by each large model for task processing;
S34: allocating initial target resources to different large models in the (t+n)-th time segment based on the resource allocation strategy, and allocating reserved resources, where the reserved resources may be a portion of the total target resources reserved to ensure the processing efficiency of tasks to be processed in the (t+n)-th time segment; and
S35: in the (t+n)-th time segment, if it is determined that execution of a target task by a first large model meets a target condition, moving the target tasks to a second large model such that the second large model executes the target tasks, where the target condition may include the efficiency of the first large model executing the target task is lower than a first threshold and/or the number of tasks executed by the first large model is larger than a second threshold.

Based on the historical records, the number and types of tasks to be processed in the (t+n)-th time segment may be predicted. Based on the predicted number and types of tasks to be processed in the (t+n)-th time segment, the initial target resources and reserved resources may be allocated to the different large models in the (t+n)-th time segment according to the target resources needed by each large model for task processing.

During the (t+n)-th time segment, each large model may use the initial target resources allocated to it to execute its corresponding tasks. For example, the large model 1 may execute the tasks 1 and 3 using its initial target resource k1, and the large model 2 may execute the tasks 2 using its initial target resource k2.

During the (t+n)-th time segment, if it is determined that the efficiency of the first large model in executing its corresponding target task is low, falling below a first threshold, for example, below 50%, the first large model may be considered to be resource-scarce. In this case, the target tasks being executed by the first large model may be directly transferred to the second large model. That is, the first large model may no longer execute the target tasks but instead continue to execute other tasks, thus avoiding inefficient execution of the target tasks.

Alternatively, in the (t+n)-th time segment, if the number of tasks executed by the first large model is determined to be larger than a second threshold, for example, larger than 150, it may be considered that the first large model is currently executing too many tasks and is experiencing resource shortages. Therefore, the target tasks may be transferred to the second large model, which then executes the target tasks, while the first large model continues to execute other tasks, thereby reducing the number of tasks executed by the first large model and avoiding inefficient execution.

To transfer the target tasks to the second large model, the compatibility value between the second large model and the target tasks may need to meet certain conditions. For example, based on a pre-set table of matching relationships between large models and tasks, one large model (also referred to as a “candidate large model”) whose compatibility value with the target tasks meets a third threshold may be determined as the second large model. The table of matching relationships between large models and tasks may represent the compatibility values of different large models for different tasks. The target tasks may then be transferred to the second large model.

Different tasks may produce different inference results on different large models. Therefore, to ensure inference quality during task execution, a table of matching relationships between large models and tasks may be pre-set to represent the compatibility values of different large models with different tasks. This compatibility value may then be used to select large models for different tasks.

Table 1 shows a table that uses compatibility values to represent the compatibility relationship between tasks and large models. The compatibility value may be a compatibility score. A higher score may indicate a higher compatibility between the large model and the task, meaning that the large model performs better when used for inference on that task. A lower score may indicate a lower compatibility between the large model and the task, meaning that the large model performs worse when used for inference on that task. An “x” in the table may indicate that the application is incompatible with the large model, meaning that the large model cannot be used for inference on that task.

TABLE 1

Large model

| | Large | Large | Large |
|---|---|---|---|
| Application | model A | model B | model C |
| Application 1 | 10 | x | 6 |
| Application 2 | 7 | 10 | x |
| Application 3 | 7 | 6 | 10 |

In Table 1, Application 1's tasks may be executed by either Large Model A or Large Model C, but Large Model A may be prioritized based on the compatibility score. If, while executing a task, Large Model A's execution efficiency falls below the first threshold, or the number of tasks executed by Large Model A exceeds the second threshold, one of the tasks may be transferred to another Large Model. For example, Application 1's tasks may be transferred to Large Model C, which then executes them, while Large Model B may be incompatible with Application 1 and cannot execute them.

Furthermore, when transferring the target task to the second large model, the following steps may be performed. Based on the pre-set table of matching relationships between large models and tasks, one large model whose compatibility score with the target task meets the third threshold may be determined. When the number of tasks currently executed by the determined large model whose compatibility score with the target task meets the third threshold does not meet the second threshold, the determined large model whose compatibility score with the target task meets the third threshold may be selected as the second large model.

That is, when the compatibility score between a certain large model and the target task reaches a third threshold, e.g., a compatibility score larger than 6, based on the large model-task matching table, the number of tasks currently executed by the large model may be further determined. When the number of tasks executed by the large model reaches the second threshold, the target task may not be transferred to the large model, and another large model may be selected. When the number of tasks executed by the large model does not reach the second threshold, the large model may be directly designated as the second large model, and the target task may be transferred to the second large model.

Alternatively, when the compatibility score between a certain large model and the target task reaches the third threshold, based on the large model-task matching table, it may be further determined whether the efficiency of the large model in executing the tasks is lower than the first threshold. The efficiency lower than the first threshold may indicate that the large model has insufficient resources to execute the tasks, and the target task cannot be transferred to the large model. Another large model may be selected. When the efficiency is higher than the first threshold, the large model may be directly designated as the second large model, and the target task may be transferred to the second large model.

In one embodiment, the resource allocation method may further include:
in the (t+n)-th time segment, when it is determined that the efficiency of the first large model in executing the target task is below the first threshold and/or the number of tasks executed by the first large model is larger than the second threshold, allocating at least a portion of the reserved resources to the first large model such that the first large model executes the target task using the initial target resources allocated to it and at least the portion of the reserved resources; continuing to monitor the efficiency of the first large model in executing the tasks; when it is determined that the efficiency of the first large model in executing the tasks is no longer below the first threshold, maintaining the current state and continuing to execute the target task using the first large model; when it is determined that the efficiency of the first large model in executing the tasks is still below the first threshold, transferring the target task to the second large model, such that the second large model may execute the target task.

The second large model may be selected by: determining a second large model whose compatibility value with the target task meets the third threshold based on a pre-set table of matching relationships between large models and tasks; or determining a large model whose compatibility value with the target task meets the third threshold based on a pre-set table of matching relationships between large models and tasks, and, when the number of tasks currently being executed by the large model whose compatibility value with the target task meets the third threshold does not meet the second threshold, selecting that large model as the second large model.

To improve the efficiency of a large model in executing tasks, when resources are insufficient, the reserved resources may be first used to supplement the large model to execute the corresponding task. This may be achieved through the request processing gateway. When the reserved resources are insufficient to support the execution of the large model, the target task may be transferred to another large model. In this case, the inference quality of the target task may be reduced, but the efficiency of the large model's task execution may be guaranteed.

The resource allocation method in the present embodiment may predict the number and types of tasks to be processed in the (t+n)-th time segment, and allocate corresponding initial target resources and reserved resources to different large models in the (t+n)-th time segment. Therefore, in the (t+n)-th time segment, when the efficiency of the first large model in executing the target task is low or the number of tasks it executes is too large, the target task may be transferred to the second large model, such that the second large model executes the target task, thereby reducing the number of tasks executed by the first large model, improving the efficiency of the first large model in executing tasks, and avoiding the situation where tasks cannot be completed in time because of insufficient resources of the large model.

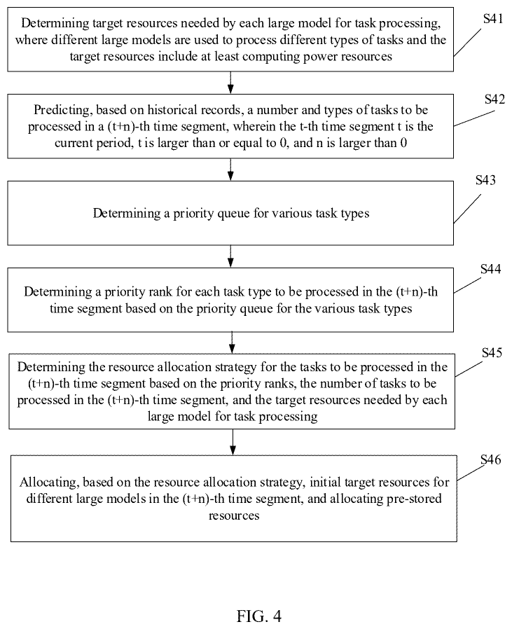

Another embodiment of the present disclosure provides another resource allocation method, as shown in FIG. 4, including:
S41: determining target resources needed by each large model for task processing, where different large models may be used to process different types of tasks and the target resources may at least include computing power;
S42: predicting the number and types of tasks to be processed in the (t+n)-th time segment based on historical records, where the t-th time segment may be the current moment segment with t larger than or equal to 0 and n larger than 0;
S43: determining a priority queue for various task types;
S44: determining the priority ranks of the task types to be processed in the (t+n)-th time segment based on the priority queue for various task types;
S45: determining a resource allocation strategy for the tasks to be processed in the (t+n)-th time segment based on the priority ranks, the number of tasks to be processed in the (t+n)-th time segment, and the target resources needed by each large model for task processing; and
S46: allocating the initial target resources for the different large models in the (t+n)-th time segment based on the resource allocation strategy, and allocating reserved resources, where the reserved resources may be a portion of the total target resources reserved to ensure the processing efficiency of the tasks to be processed in the (t+n)-th time segment.

The tasks may be tasks in the cloud computing process, and the computing power resources in the target resources allocated based on the resource allocation strategy may be the computing power resources of the graphics processing units.

The target resources needed by each large model for task processing may be determined. Based on the historical records, the number and types of tasks to be processed in the (t+n)-th time segment may be predicted. Based on the predicted number and types of tasks to be processed in the (t+n)-th time segment, the initial target resources and reserved resources may be allocated to the different large models in the (t+n)-th time segment according to the target resources needed by each large model for task processing, to ensure that the tasks to be processed in the (t+n)-th time segment may be processed promptly and efficiently.

The resource allocation strategy for the (t+n)-th time segment may be determined based on the predicted priority ranks of the tasks to be processed in the (t+n)-th time segment, the number and types of tasks to be processed in the (t+n)-th time segment, and the target resources needed by each large model for task processing.

In one embodiment, inference tasks used in production environments may be categorized as online tasks and nearline tasks based on their latency sensitivity. Online tasks may be highly sensitive to latency and may be designated as high-latency tasks. These may be typical inference tasks that respond to user requests in real time and may be given the highest priority. Nearline tasks, typically batch processing tasks, may have lower latency needs for individual inferences but need completion times of hours to minutes for a batch of data. These low-latency tasks may be designated as low-priority tasks.

The request processing gateway may serve as the entry point for all inference requests, routing them to appropriate nodes and containers. When multiple tasks arrive at the entry point simultaneously, their execution order may be determined based on their priorities. High-priority tasks may get target resources at high priority, while low-priority tasks must wait for the high-priority tasks to complete before they may be executed. For example, if Task A has a higher priority than Tasks B and C, Task A may be executed first. Alternatively, if Application 1 has a higher priority than Applications 2 and 3, the priority of tasks in Application 1 may be higher than the priority of tasks in Application 2 and Application 3, and the execution of the tasks in Application 1 may be prioritized.

The priority queue may be determined for various tasks based on their latency sensitivities. This priority queue may be predetermined. After predicting the task types to be processed in the (t+n)-th time segment, the priority rank of each task type to be processed in the (t+n)-th time segment may be determined according to the priority queue.

Further, after determining the priority ranks of the task types to be processed in the (t+n)-th time segment, task priorities may be dynamically adjusted based on parameters such as task waiting time, task size, or system load. For example, if the waiting time of Task 1 exceeds a certain threshold, Task 1's priority may be increased. Alternatively, if resource shortages occur, such as if the execution efficiency of Large model A is low and falls below a certain threshold, lower-priority tasks may be suspended and only higher-priority tasks may be executed to avoid resource preemption and ensure efficient execution of high-priority tasks.

After determining the priority ranks of the task types to be processed in the (t+n)-th time segment, the resource allocation strategy for each large model in the (t+n)-th time segment may be determined based on the priority ranks, the number of tasks to be processed, and the target resources needed for each large model to execute its tasks.

After determining the priority rank of the task types to be processed in the (t+n)-th time segment, one large model that will execute tasks of one task type may be determined. Then, the tasks needed by each large model may be sorted according to the priority ranks of the task types, and the number of tasks of each task type in the sorted order for each large model may be determined, to determine the target resources needed for each task type in the sorted order for each large model, given the corresponding number of tasks. The target resources may then be allocated to each large model based on the target resources needed for each task type in the sorted order for each large model.

For example: in the (t+n)-th time segment, the tasks that the large model 1 needs to process include: type a tasks, type b tasks and type c tasks. According to the priority ranks corresponding to the task types to be processed in the (t+n)-th time segment, the priority of the above three tasks may be determined from high to low as: type b tasks, type a tasks, type c tasks. The number of type b tasks may be 5, the number of type a tasks may be 10, and the number of type c tasks may be 1. The unit target resources needed for the large model 1 to execute one type b task may be k, then the unit target resources needed for the large model 1 to execute 5 type b tasks may be 5k. The unit target resources needed for the large model 1 to execute one type a task may be m, then the unit target resources needed for the large model 1 to execute 10 type a tasks may be 10m. The unit target resource needed for the large model 1 to execute one type c task may be n. Then, it may be determined that the target resources needed by the large model 1 during the time interval of executing type b tasks may be 5k, the target resources needed during the time interval of executing type a tasks may be 10m, and the target resources needed during the time interval of executing type c tasks may be n. Therefore, the (t+n)-th time segment may be divided into three time intervals. The first time interval may be used to execute type b tasks, in which case the target resources allocated to the large model 1 may be 5k. The second time interval may be used to execute type a tasks, in which case the target resources allocated to the large model 1 may be 10m. The third time interval may be used to execute type c tasks, in which case the target resources allocated to the large model 1 may be n. The length of each time interval may be predicted based on the historical records, where k, m, and n may be all positive numbers.

Alternatively, after determining that the tasks needed for each large model are sorted according to the priority ranks of their task types, for any large model, the target resources needed for all tasks of the highest-priority task type within the large model may be determined based on the number of tasks of the highest-priority task type and the unit target resources needed for the large model to execute tasks of that type. The target resources may then be allocated directly based on the target resources needed for all tasks of the highest-priority task type, ensuring that sufficient target resources are available for the tasks of the highest-priority task type during execution.

For lower-priority tasks, when all tasks of a task type with a lower priority than the highest priority are executed, for example, when task type 1 is the highest-priority task type for a large model and task type 2 is a task type with a lower priority than task type 1, the total target resources needed for executing task type 1 may be m, and the total target resources needed for executing task type 2 may be n. When m is larger than n, meaning that the target resources needed for executing the lower-priority task type is less than the target resources needed for executing all tasks of the highest-priority task type, m-n, that is, the remaining target resources allocated to the large model when executing task type 2, may be allocated to other large models when the other large models have resource shortage when executing tasks, to prevent them from executing tasks inefficiently. When m is less than n, meaning that the target resources needed to execute the lower-priority task type is larger than the target resources needed to execute all tasks of the highest-priority task type, n-m may be the difference between the target resources needed by the large model to execute task type 2 and all the target resources allocated to the large model, and n-m resources may be needed to guarantee the efficiency of executing task type 2. In this case, the reserved resources may be used to provide the large model with the target resources for executing task type 2, or the remaining resources of large models with remaining target resources may be used to provide the large model with target resources for executing task type 2.

In the resource allocation method disclosed in this embodiment, when determining the resource allocation strategy for the tasks to be processed in the (t+n)-th time segment, the target resources needed by each large model when performing task processing may be determined, and the number of tasks and task types to be processed in the (t+n)-th time segment may be predicted. Then, the priority ranks corresponding to the task types to be processed in the (t+n)-th time segment may be determined. The resource allocation strategy corresponding to the tasks to be processed in the (t+n)-th time segment based on the priority ranks, the number of tasks to be processed in the (t+n)-th time segment, and the target resources needed by each large model when performing task processing, to ensure that the target resources allocated to the large models in the (t+n)-th time segment according to the resource allocation strategy may support the task execution of the large models and ensure a certain execution efficiency.

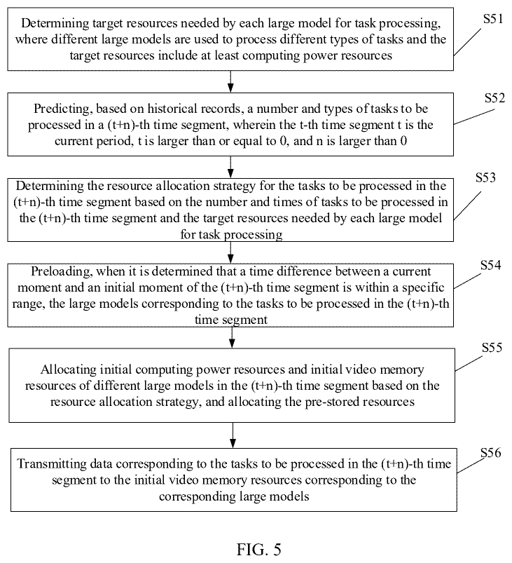

Another embodiment of the present disclosure provides another resource allocation method, as shown in FIG. 5, including:
S51: determining target resources needed by each large model for task processing, where different large models may be used to process different types of tasks and the target resources may at least include computing power resources;
S52: predicting the number and types of tasks to be processed in the (t+n)-th time segment based on historical records, where the t-th time segment may be the current moment segment with t larger than or equal to 0 and n larger than 0;
S53: determining a resource allocation strategy for the (t+n)-th time segment based on the number and types of tasks to be processed in the (t+n)-th time segment and the target resources needed by each large model for task processing;
S54: when the time difference between the current moment and the initial moment of the (t+n)-th time segment is determined to be within a specified range, preloading the large models corresponding to the tasks to be processed in the (t+n)-th time segment;
S55: allocating the initial computing power resources and initial video memory resources to the different large models in the (t+n)-th time segment based on the resource allocation strategy, and allocating the reserved resources; and
S56: transferring the data corresponding to the tasks to be processed in the (t+n)-th time segment to the initial video memory resources corresponding to the large models.

The target resources needed by each large model for task processing may be determined. Based on the historical records, the number and types of tasks to be processed in the (t+n)-th time segment may be predicted. Based on the predicted number and types of tasks to be processed in the (t+n)-th time segment, the initial target resources and reserved resources may be allocated to the different large models in the (t+n)-th time segment according to the target resources needed by each large model for task processing, to ensure that the tasks to be processed in the (t+n)-th time segment may be processed promptly and efficiently.

After determining the resource allocation strategy for the (t+n)-th time segment, resource allocation for the (t+n)-th time segment may be performed only when a specific time period is reached, ensuring that the various models in the (t+n)-th time segment execute inference tasks promptly and do not affect the execution of tasks for various models in time segments before the (t+n)-th time segment.

The time difference between the current moment and the initial moment of the (t+n)-th time segment may be determined to be within the specific range, that is, the time difference from the current moment to the (t+n)-th time segment may be determined to be within the specific range. When it is, the current moment may be close to the (t+n)-th time segment, and resource allocation for the (t+n)-th time segment may be performed. If it is not, the current moment may be far from the (t+n)-th time segment, and it may take some time before the (t+n)-th time segment arrives. Therefore, resource allocation for the (t+n)-th time segment may not be necessary.

When the time difference between the current moment and the (t+n)-th time segment is determined to be within the specific range, resource allocation for the (t+n)-th time segment may begin. The large models corresponding to the pending tasks in the (t+n)-th time segment may be preloaded to ensure that they are fully loaded when the (t+n)-th time segment arrives.

Further, once the time difference between the current moment and the (t+n)-th time segment is determined to be within the specific range, it may be necessary to allocate the initial computing power and memory resources to the different large models in the (t+n)-th time segment based on the resource allocation strategy, as well as to allocate reserved resources. This means the initial computing power and memory resources needed by each large model in the (t+n)-th time segment may be allocated, ensuring that the large model is able to directly utilize its allocated initial target resources to execute the corresponding task upon reaching the (t+n)-th time segment such that the large model has sufficient resources to perform the task.

Further, the data corresponding to the tasks to be processed in the (t+n)-th time segment may need to be transferred to the initial memory resources corresponding to the corresponding large models. That is, after allocating the corresponding initial computing power resources and initial memory resources to each large model, the data needed for each large model to execute the tasks may also need to be stored in advance. For example, when it is predicted that the task A is to be executed by the large model 1 in the (t+n)-th time segment, the initial memory resources allocated to the large model 1 may be the memory resource 1, and the data needed for the task A may be the data a. Therefore, the data a may be transferred to the memory resource 1 before the (t+n)-th time segment arrives. This may allow the large model 1, which has been preloaded, to directly execute the task A using the data a in the memory resource 1 when the (t+n)-th time segment arrives, eliminating the need to load the large model 1 after the (t+n)-th time segment arrives. Allocating the initial target resources to the large model 1 and transferring the data a to the memory resource may improve the efficiency of data processing by the large model in the (t+n)-th time segment. Also, the above preprocessing process may only be performed when the time difference between the current moment and the initial moment of the (t+n)-th time segment is within the specific range, avoiding the problem of insufficient resources when the large models execute the tasks in the time segments before the (t+n)-th time segment.

The resource allocation method disclosed in this embodiment may further include:
determining the difference between the target resources needed in the resource allocation strategy for the (t+n)-th time segment and the target resources at the current moment, and releasing the target resources for the (t+n)-th time segment based on the difference.

When performing resource allocation for the (t+n)-th time segment, the amount of target resources allocated to each model at the current moment may be first determined, and then the amount of target resources needed by each model for the (t+n)-th time segment may be predicted. The resources allocated to each model may be adjusted based on the difference between the target resources needed in the resource allocation strategy for the (t+n)-th time segment and the target resources at the current moment, to ensure that the target resources allocated to each model in the (t+n)-th time segment comply with the predetermined resource allocation strategy, thereby avoiding resource shortages or resource waste.

When performing resource allocation for the (t+n)-th time segment, the amount of target resources allocated to each model at the current moment may be determined. The current moment may be a moment in a time segment before the (t+n)-th time segment, and the time segment where the current moment is located may be closest to the (t+n)-th time segment. The amount of target resources allocated to each model may not change between the current moment and the (t+n)-th time segment. Therefore, the target resources may only need to be released based on the difference between the current amount of target resources allocated to each model and the predicted amount of target resources allocated to each model for the (t+n)-th time segment. There may be no need to reclaim all resources and then release them again, thus ensuring efficient resource allocation.

The resource allocation method disclosed in this embodiment may determine the target resources needed by each large model when performing task processing, and the number and types of tasks to be processed in the (t+n)-th time segment may be predicted based on the historical records. Then, based on the number and types of tasks to be processed in the (t+n)-th time segment and the target resources needed by each large model when performing task processing, the resource allocation strategy for the (t+n)-th time segment may be determined. When it is determined that the time difference between the current moment and the initial moment of the (t+n)-th time segment is within the specific range, resource allocation may be performed for the large models applied in the (t+n)-th time segment to ensure that resource allocation is completed in advance before reaching the (t+n)-th time segment. When reaching the (t+n)-th time segment, the large models may be directly used to execute the corresponding resources, thereby ensuring the efficiency of the large models in executing tasks and improving the task processing speed.

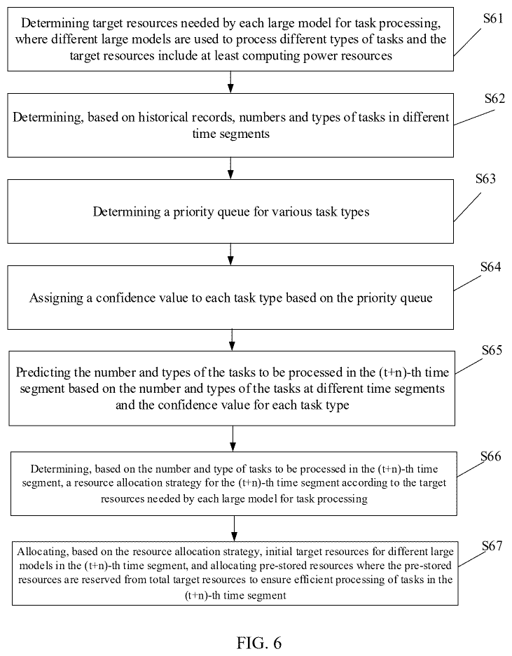

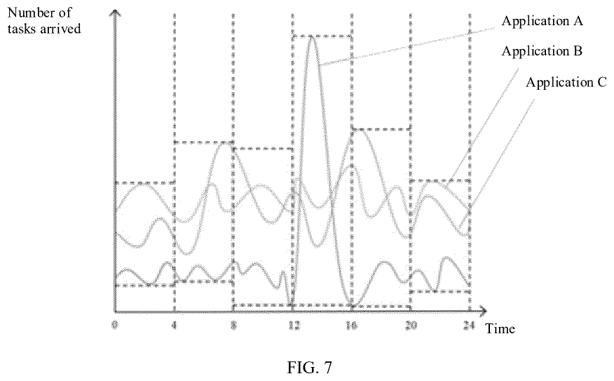

Another embodiment of the present disclosure provides another resource allocation method, as shown in FIG. 6, including:
S61: determining target resources needed by each large model for task processing, where different large models may be used to process different types of tasks and the target resources may at least include computing power;
S62: determining numbers of tasks and types of tasks for different time segments based on the historical records;
S63: determining a priority queue for various task type;
S64, configuring a confidence value for each task type based on the priority queue;
S65: predicting the number and types of tasks to be processed in the (t+n)-th time segment based on historical records based on the numbers of tasks and types of tasks for different time segments and the confidence value of each task type;
S66: determining a resource allocation strategy for the tasks to be processed in the (t+n)-th time segment based on the number of tasks to be processed in the (t+n)-th time segment, and the target resources needed by each large model for task processing; and
S67: allocating the initial target resources for the different large models in the (t+n)-th time segment based on the resource allocation strategy, and allocating reserved resources, where the reserved resources may be a portion of the total target resources reserved to ensure the processing efficiency of the tasks to be processed in the (t+n)-th time segment.

The target resources needed by each large model for task processing may be determined. Based on the historical records, the number and types of tasks to be processed in the (t+n)-th time segment may be predicted. Based on the predicted number and types of tasks to be processed in the (t+n)-th time segment, the initial target resources and reserved resources may be allocated to the different large models in the (t+n)-th time segment according to the target resources needed by each large model for task processing, to ensure that the tasks to be processed in the (t+n)-th time segment may be processed promptly and efficiently.

Determining the number and types of tasks to be processed in the (t+n)-th time segment based on the historical records, may include: determining the number and types of tasks in different time segments based on the historical records. The estimated task volume for different time segments within a recording cycle may be estimated using the historically monitored task arrival values for different applications.

The change of the number of tasks over time for different types of applications may exhibit different curves or resource needs. FIG. 7 is a schematic diagram showing the task volumes for applications A, B, and C within a recording period. For example, taking a recording period being a single day as an example, the number of tasks for the application A, the highest-priority application, increases sharply during a certain time segment of the day. The application B, the second-highest-priority application, maintains a relatively stable task volume with no significant fluctuations. The application C, the lowest-priority application, experiences two fluctuations during the day. In FIG. 7, the horizontal axis is divided into different time segments. The predicted values for each time segment may be used to directly allocate the minimum computing power and determine the reserved resources.

For one application with the highest priority, tasks in that application may have a higher priority than those in other applications. Of course, different tasks within the same application may also have different priorities.

Since different large models handle tasks with different priorities, different confidence values may be configured for large models performing different tasks during prediction. Large models with higher-priority tasks may have higher corresponding confidence values, while large models with lower-priority tasks may have lower corresponding confidence values. For example, a set of confidence values may be set to [30%, 50%, 70%, 90%], where the confidence value of the large models corresponding to the highest-priority task is 90%, the confidence value of the large models corresponding to the second-highest-priority task is 70%, and the confidence value of the large models corresponding to the lowest-priority task is 30%. This may ensure that predictions for higher-priority tasks are more accurate and sufficient target resources may be allocated to their corresponding large models, ensuring the processing efficiency of high-priority tasks.

After configuring the confidence value for each model, the number and types of tasks for the (t+n)-th time segment may be predicted based on the confidence values and the number and types of tasks for different time segments determined based on the historical data. Alternatively, the number and types of tasks for the next moment, i.e., the (t+n)-th time segment, may be predicted based on the confidence values and the number and types of tasks in the time segment immediately preceding the (t+n)-th time segment.

In some embodiments, further, after predicting the number and types of tasks for the (t+n)-th time segment, the resource allocation strategy for the (t+n)-th time segment may need to consider the compatibility between the large models and the target resources.

In one embodiment, the target resources may be resources in the GPU resource pool. The GPU resource pool may offer at least three types of resources: multi-GPU collective inference, inference using a single GPU of different models, and vGPU inference.

The multi-GPU collective inference may utilize multiple GPUs for parallel processing to accelerate the inference process of large models. Because of the varying parameter sizes of different large models, some very large models cannot fit on a single GPU. Therefore, the large model must be deployed across multiple GPUs, using a framework to manage synchronization and communication strategies.

Inference on a single GPU of different models, including GPUs of mixing models from different manufacturers, may take into account the specific characteristics of each GPU, such as compute power or memory bandwidth, and allocate tasks based on the GPU's strengths. For example, memory-intensive tasks may be allocated to GPUs with larger memory, and computationally demanding tasks may be allocated to GPUs with higher FLOPs (floating-point operations per second).

vGPU (virtual GPU) inference is a technology that allows multiple virtual machines to share a single physical GPU. vGPU partitions one physical GPU into multiple virtual slices, each assigned to a virtual machine, enabling independent access and utilization of GPU resources. Alternatively, vGPU is able to use time slicing, allowing multiple VMs to share a single GPU by dividing processing time into discrete slices. Each slice sequentially allocates a portion of the GPU's compute power and memory resources to different tasks.

Matching the large models with the target resources may need considering not only compute power, storage bandwidth, and memory capacity, but also deployment methods and compatibility.

For example, the large model 1 may be able to utilize multi-GPU joint inference and vGPU inference, but cannot utilize resources from a single GPU of a different model. The large model 2 may be able to utilize multi-GPU joint inference, vGPU inference, and partial resources from a single GPU, to perform tasks.

Based on the predicted number and types of tasks to be processed in the (t+n)-th time segment, allocating the target resources to different large models, may include: allocating the initial target resources and the reserved resources for each model. Resource allocation may take into account the computing power and video memory needed by each model to execute tasks, as well as the compatibility between the large models and the target resources. For high-priority tasks, target resources may be allocated based on the upper limit of the confidence value. For tasks other than high-priority tasks, target resources may be allocated within the confidence range. Since the predictions may be inaccurate, resources must be reserved to handle unexpected situations.

During task processing, tasks, large models, and target resources may be combined based on the target resources needed by each model, the resource allocation strategy, and compatibility between the large models and the target resources. Combinatorial optimization may be used to achieve the optimal hybrid strategy and computing power management.

The goal of combinatorial optimization may be to improve the target resources' ability to support the elastic demands of the tasks of the large models and to improve inference efficiency. The target resources' ability to support the elastic demands of the tasks of the large models may be expressed by the number of tasks assigned to the target resources corresponding to the large models. Inference efficiency may be expressed by the input token length of the tasks, the average output token length of the tasks, or the average token generation time of the large models.

For example, the optimization goal may be achieved by applying constraints including that: each application's tasks need be assigned to the corresponding large model; the graphics memory of the GPU allocated to the large model cannot exceed the GPU's maximum graphics memory; the computing power of the GPU allocated to the large model cannot exceed the GPU's maximum computing power; the GPU need to be compatible with the large model; the tasks assigned to the model cannot exceed its processing capacity; the inference time caused by task queuing cannot exceed a maximum threshold; the predicted number of tasks for the (t+n)-th time segment cannot exceed the processing capacity of the initial target resources and the initial reserved resources corresponding to the large model; the sum of reserved resources allocated to different applications cannot exceed the total reserved resources; the number of GPUs allocated to different models cannot exceed the number of compatible GPUs/vGPUs; one large model needs multiple GPUs joint interference of specific models; vGPU virtualization can be used to improve resource utilization and system processing power for one large model; different large models can be run in different GPU environments, ensuring that the inference time for high-priority tasks does not exceed the SLAs (Service Level Agreements); based on a forecast of the number of GPUs/vGPUs and large model instances needed for a certain task request scale, different total cache capacities are obtained. Because different large models may not fit on any cached GPU, different types of GPU caches may be needed to load the corresponding large models. Based on the forecast, the processing capacity of the large model for a specific task in the (t+n)-th time segment can be expanded using reserved resources.

The optimization objectives may include: minimizing the loading time of large models for different tasks, minimizing the inference time of the large models for high-priority tasks, minimizing the failure of the large models for different tasks to meet SLAs (Service Level Agreements), minimizing the number of the large model loaded and unloaded in the (t+n)-th time segment, or minimizing the time between releasing reserved resources and reloading different large models.

The resource allocation method disclosed in this embodiment may monitor the indicators of the target resources through tools such as NVIDIA or Zabbix. The regularly checked indicators may include utilization, memory usage, temperature, or power consumption. Task scheduling may be adjusted based on the currently set utilization threshold, and tasks may be dynamically allocated based on real-time data.

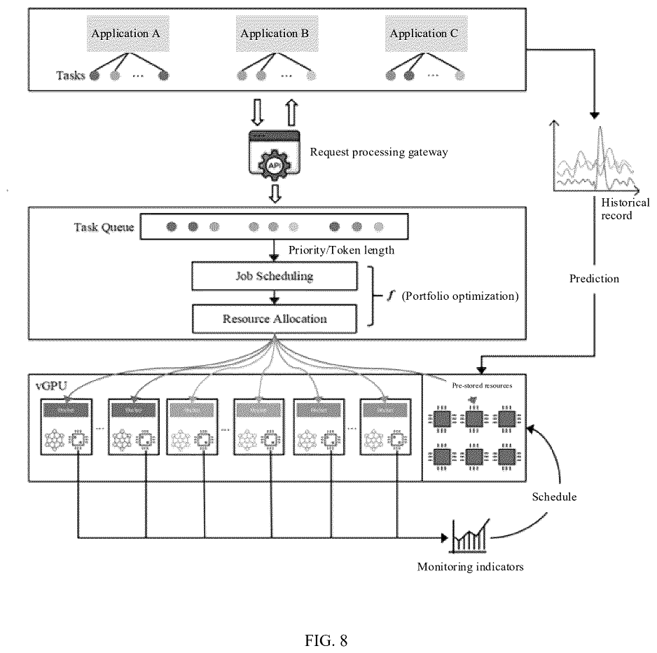

Another embodiment provides another resource allocation method, as shown in FIG. 8, including: predicting the number and types of tasks to be processed in the (t+n)-th time segment based on the historical records of each application; based on this prediction, allocating the initial target resources to different large models in the (t+n)-th time segment, and allocating the reserved resources. Subsequently, the request processing gateway may receive inference requests input by each application, obtain the tasks to be processed, determine the priority ranks of the tasks, and then optimize job scheduling and resource allocation. Each large model may then utilize the target resources to execute the corresponding tasks. Further, the target resources may be regularly monitored to adjust task scheduling.

In the resource allocation method disclosed in this embodiment, when predicting the number and types of tasks to be processed in the (t+n)-th time segment based on the historical records, a confidence value may be assigned to each task type based on the priority queue and the confidence value parameter may be added for the prediction. This may ensure the accuracy of the predicted number and types of tasks to be processed in the (t+n)-th time segment, and further incorporate efficient resource utilization into the resource allocation process.

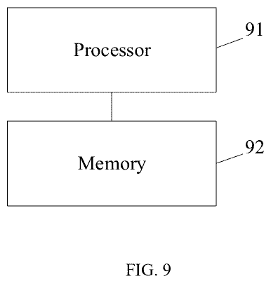

The present disclosure also provides an electronic device, as shown in FIG. 9, including a processor 91 and a memory 92.

The processor 91 may be configured to determine the target resources needed by each large model for task processing. Different large models may be configured to process different types of tasks, and the target resources may include at least computing power. The processor 91 may be further configured to predict the number and types of tasks to be processed in the (t+n)-th time segment based on historical records, where the t-th time segment is the current time segment with t being larger than or equal to 0 and n being larger than 0; based on the number and types of tasks to be processed in the (t+n)-th time segment, and in accordance with the target resources needed by each large model for task processing, determining a resource allocation strategy for the (t+n)-th time segment; and allocating the initial target resources to different large models in the (t+n)-th time segment based on the resource allocation strategy, and allocating reserved resources, where the reserved resources are reserved from the total target resources to ensure efficient processing of tasks in the (t+n)-th time segment.

The memory 92 may be configured to store the programs needed by the processor to execute the above-described processing.

The electronic device disclosed in this embodiment is implemented based on the resource allocation method disclosed in the above-described embodiments and will not be further described here.

In the electronic device disclosed in this embodiment, the target resources needed by each large model when performing task processing may be determined. Different large models may be used to process different types of tasks, and the target resources may include at least computing power resources. Based on the historical records, the number of tasks to be processed and the types of tasks may be predicted in the (t+n)-th time segment, where the t-th time segment may be the current moment segment with t larger than or equal to 0 and n larger than 0. Based on the number of tasks to be processed and the types of tasks in the (t+n)-th time segment, and according to the target resources needed by each large model when performing task processing, the resource allocation strategy for the (t+n)-th time segment may be determined. Based on the resource allocation strategy, the initial target resources of different large models in the (t+n)-th time segment may be allocated, and the reserved resources may be allocated. The reserved resources may be part of the resources reserved from the total target resources to ensure the processing efficiency of the tasks processed in the (t+n)-th time segment. The number and types of tasks to be processed in the (t+n)-th time segment may be determined and then the resource allocation strategy may be determined based on the number and types of tasks to be processed in the (t+n)-th time segment and the target resources needed by each large model when processing the tasks. Based on this, the initial target resources of different large models in the (t+n)-th time segment and the allocated reserved resources may be allocated to ensure that each task to be processed in the (t+n)-th time segment is able to executed by the corresponding large model according to its needed target resources, ensuring that the large model has sufficient resources to execute the corresponding tasks and avoid resource waste and resource shortage.

It should also be noted that the apparatus embodiments described above are merely illustrative. The units described as separate components may or may not be physically separate. The components shown as units may or may not be physical units, that is, they may be located in one location or distributed across multiple network units. Some or all of the modules can be selected based on actual needs to achieve the objectives of these embodiments. Furthermore, in the apparatus embodiments drawings provided herein, the connections between modules indicate a communication connection between them, which can be implemented as one or more communication buses or signal lines.

Through the above description of the embodiments, those skilled in the art will clearly understand that the present disclosure can be implemented using software plus necessary general-purpose hardware. Of course, it can also be implemented using specialized hardware, including application-specific integrated circuits, dedicated CPUs, dedicated memories, and dedicated components. Generally speaking, any function performed by a computer program can be easily implemented using the corresponding hardware. Furthermore, the specific hardware structures used to implement the same function can vary, such as analog circuits, digital circuits, or dedicated circuits. In some embodiments, software implementation is often the preferred implementation method. Based on this understanding, the technical solution of the present disclosure or the portion that contributes to the prior art, may be embodied in the form of a software product. This computer software product may be stored on a readable storage medium, such as a computer floppy disk, a USB flash drive, a removable hard drive, a ROM, a RAM, a magnetic disk, or an optical disk, and may include instructions for enabling a computer device (which may be a personal computer, training device, or network device, etc.) to execute the methods provided by any embodiment of the present disclosure.

In the above embodiments, all or part of the methods may be implemented using software, hardware, firmware, or any combination thereof. When implemented using software, all or part of the methods can be implemented in the form of a computer program product. The various embodiments of the present disclosure are described in a progressive or parallel manner, with each embodiment focusing on the differences from other embodiments. Similar or identical portions between the various embodiments can be referenced separately. As for the devices and electronic devices disclosed in the embodiments, since they correspond to the methods disclosed in the embodiments, the description is relatively simple. For relevant details, references may be made to the method embodiments.

The computer program product includes one or more computer instructions. When the computer program instructions are loaded and executed on a computer, the process or function described in the embodiments of the present disclosure is implemented in whole or in part. The computer can be a general-purpose computer, a special-purpose computer, a computer network, or other programmable devices. The computer instructions can be stored in a computer-readable storage medium, or transmitted from one computer-readable storage medium to another computer-readable storage medium. For example, the computer instructions can be transmitted from a website, a computer, a training device or a data center by wired (e.g., coaxial cable, optical fiber, digital subscriber line (DSL)) or wireless (e.g., infrared, wireless, microwave, etc.) mode to another website, another computer, another training device or another data center. The computer-readable storage medium can be any available medium that a computer can store or a data storage device such as a training device, a data center, etc. that includes one or more available media integrations. The available medium can be a magnetic medium, (e.g., a floppy disk, a hard disk, a tape), an optical medium (e.g., a DVD), or a semiconductor medium (e.g., a solid-state drive (SSD)).

The above describes in detail a plurality of embodiments of the present disclosure, but the present disclosure is not limited to these specific embodiments. Those skilled in the art can make various variations and modifications based on the concept of the present disclosure, and these variations and modifications shall fall within the scope of the present disclosure.

What is claimed is:

1. A resource allocation method comprising:
determining target resources needed by each of a plurality of large models for task processing, different ones of the plurality of large models being used to process different types of tasks, and the target resources including at least computing power resources;
predicting, based on historical records, a number of candidate tasks and types of the candidate tasks to be processed in a future time segment;
determining, based on the number and the types, a resource allocation strategy for the future time segment according to the target resources needed by each of the plurality of large models for task processing; and
allocating, based on the resource allocation strategy, initial target resources for each of the plurality of large models in the future time segment, and allocating reserved resources, the reserved resources being reserved from total target resources.

2. The method according to claim 1, further comprising:
in the future time segment, in response to determining that execution of a target task by one large model satisfies a target condition, allocating at least a portion of the reserved resources to the one large model, to enable the one large model to execute the target task using the initial target resources and the at least a portion of the reserved resources;
wherein the target condition includes at least one of:
an efficiency of the one large model executing the target task being lower than a first threshold; or
a number of tasks executed by the one large model being larger than a second threshold.

3. The method according to claim 1, further comprising:
in the future time segment, in response to determining that execution of a target task by a first large model satisfies a target condition, transferring the target task to a second large model such that the second large model performs the target task;
wherein the target condition includes at least one of:
an efficiency of the one large model executing the target task being lower than a first threshold; or
a number of tasks executed by the one large model being larger than a second threshold.

4. The method according to claim 3, wherein transferring the target task to the second large model includes:
determining, based on a pre-set matching relationship table between large models and tasks, the second large model having a compatibility value with the target task reaching a third threshold, the matching relationship table characterizing compatibility values of different large models for different tasks; and
transferring the target task to the second large model.

5. The method according to claim 4, wherein determining the second large model includes:
determining, based on the pre-set matching relationship table, a candidate large model having a compatibility value with the target task reaching the third threshold; and
in response to determining that a number of tasks currently executed by the candidate large model does not reach the second threshold, determining the candidate large model as the second large model.

6. The method according to claim 1, wherein determining the resource allocation strategy includes:
determining a priority queue for various task types;
determining priority ranks for the types of the candidate tasks based on the priority queue; and
determining the resource allocation strategy based on the priority ranks, the number of the candidate tasks, and the target resources needed by each of the plurality of large models for task processing.

7. The method according to claim 1, wherein the tasks are tasks in a cloud computing process, and the computing power resources are computing power resources of graphics processing units.

8. The method according to claim 1, wherein allocating the initial target resources for each of the plurality of large models in the future time segment and allocating the reserved resources includes:
preloading, in response to determining that a time difference between a current moment and an initial moment of the future time segment is within a specific range, the large models corresponding to the candidate tasks;
allocating initial computing power resources and initial video memory resources for different large models in the future time segment based on the resource allocation strategy, and allocating the reserved resources; and
transmitting data corresponding to the candidate tasks to the initial video memory resources corresponding to the corresponding ones of the large models.

9. The method according to claim 1, further comprising:
determining a difference between target resources needed in the resource allocation strategy and target resources at a current moment; and
releasing target resources for the future time segment based on the difference.

10. The method according to claim 1, wherein predicting the number and the types of the candidate tasks includes:
determining a number and types of tasks for each of different time segments based on the historical records;
determining a priority queue for various task types;
assigning a confidence value to each of the various task types based on the priority queue; and
predicting the number and the types of the candidate tasks based on the number and the types of the tasks at the different time segments and the confidence values for the various task types.

11. An electronic device comprising:
a processor; and
a memory storing instructions that, when executed by the processor, cause the electronic device to:
determine target resources needed by each of a plurality of large models for task processing, different ones of the plurality of large models being used to process different types of tasks, and the target resources including at least computing power resources;
predict, based on historical records, a number of candidate tasks and types of the candidate tasks to be processed in a future time segment;
determine, based on the number and the types, a resource allocation strategy for the future time segment according to the target resources needed by each of the plurality of large models for task processing; and
allocate, based on the resource allocation strategy, initial target resources for each of the plurality of large models in the future time segment, and allocate reserved resources, the reserved resources being reserved from total target resources.

12. The electronic device according to claim 11, wherein:
the instructions, when executed by the processor, further cause the electronic device to, in the future time segment, in response to determining that execution of a target task by one large model satisfies a target condition, allocate at least a portion of the reserved resources to the one large model, to enable the one large model to execute the target task using the initial target resources and the at least a portion of the reserved resources; and
the target condition includes at least one of:
an efficiency of the one large model executing the target task being lower than a first threshold; or
a number of tasks executed by the one large model being larger than a second threshold.

13. The electronic device according to claim 11, wherein:
the instructions, when executed by the processor, further cause the electronic device to, in the future time segment, in response to determining that execution of a target task by a first large model satisfies a target condition, transfer the target task to a second large model such that the second large model performs the target task; and
the target condition includes at least one of:
an efficiency of the one large model executing the target task being lower than a first threshold; or
a number of tasks executed by the one large model being larger than a second threshold.

14. The electronic device according to claim 13, wherein the instructions, when executed by the processor, further cause the electronic device to, when transferring the target task to the second large model:
determine, based on a pre-set matching relationship table between large models and tasks, the second large model having a compatibility value with the target task reaching a third threshold, the matching relationship table characterizing compatibility values of different large models for different tasks; and
transfer the target task to the second large model.

15. The electronic device according to claim 14, wherein the instructions, when executed by the processor, further cause the electronic device to, when determining the second large model:
determine, based on the pre-set matching relationship table, a candidate large model having a compatibility value with the target task reaching the third threshold; and
in response to determining that a number of tasks currently executed by the candidate large model does not reach the second threshold, determine the candidate large model as the second large model.

16. The electronic device according to claim 11, wherein the instructions, when executed by the processor, further cause the electronic device to, when determining the resource allocation strategy:
determine a priority queue for various task types;
determine priority ranks for the types of the candidate tasks based on the priority queue; and
determine the resource allocation strategy based on the priority ranks, the number of the candidate tasks, and the target resources needed by each of the plurality of large models for task processing.

17. The electronic device according to claim 11, wherein the tasks are tasks in a cloud computing process, and the computing power resources are computing power resources of graphics processing units.

18. The electronic device according to claim 11, wherein the instructions, when executed by the processor, further cause the electronic device to, when allocating the initial target resources for each of the plurality of large models in the future time segment and allocating the reserved resources:
preload, in response to determining that a time difference between a current moment and an initial moment of the future time segment is within a specific range, the large models corresponding to the candidate tasks;
allocate initial computing power resources and initial video memory resources for different large models in the future time segment based on the resource allocation strategy, and allocate the reserved resources; and
transmit data corresponding to the candidate tasks to the initial video memory resources corresponding to the corresponding ones of the large models.

19. The electronic device according to claim 11, wherein the instructions, when executed by the processor, further cause the electronic device to:
determine a difference between target resources needed in the resource allocation strategy and target resources at a current moment; and
release target resources for the future time segment based on the difference.

20. A non-transitory computer-readable storage medium storing instructions that, when executed by a processor, cause an electronic device including the processor to:
determine target resources needed by each of a plurality of large models for task processing, different ones of the plurality of large models being used to process different types of tasks, and the target resources including at least computing power resources;
predict, based on historical records, a number of candidate tasks and types of the candidate tasks to be processed in a future time segment;
determine, based on the number and the types, a resource allocation strategy for the future time segment according to the target resources needed by each of the plurality of large models for task processing; and
allocate, based on the resource allocation strategy, initial target resources for each of the plurality of large models in the future time segment, and allocate reserved resources, the reserved resources being reserved from total target resources.
